(19) United States
(12) Patent Application Publication
(10) Pub. No.: US 2007/0165351 A1
(43) Pub. Date: Jul. 19, 2007

(54) Optically ignited spark gap

(76) Inventor: Peter Menke, Oberfullbach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/597,128

(22) PCT Filed: Jan. 12, 2005
(86) PCT No.: PCT/DE05/00048

§ 371 Date: Jul. 12, 2006

(30) Foreign Application Priority Data
Jan. 13, 2004 (DE) 10 2004 002 582.7

(51) Int. Cl. H02H 3/22

(52) U.S. Cl. 361/117

(57) ABSTRACT

An overvoltage protector (1) has a spark gap (2) with opposing electrodes (3) and a light source for generating an ignition light in accordance with the trigger signals of a control unit, the ignition light being configured to directly ignite the spark gap (2). A reliable ignition of the spark gap is facilitated by equipping the overvoltage protector with an optical fibre (15) for conducting the ignition light to the spark gap (2).

### CROSS-REFERENCE TO RELATED APPLICATIONS

This application is a U.S. national stage application of International Application No. PCT/DE2005/000048 filed Jan. 12, 2005, which designates the United States of America, and claims priority to German application number DE 10 2004 002 582.7 filed Jan. 13, 2004, the contents of which are hereby incorporated by reference in their entirety.

### TECHNICAL FIELD

The invention relates to overvoltage protection having a spark gap which has mutually opposite electrodes, with a light source for production of an ignition light as a function of initiation signals from a control unit, with the ignition light being designed for direct ignition of the spark gap.

### BACKGROUND

Overvoltage protection such as this is already known from DE 197 18 660 A1. The overvoltage protection described there has a spark gap which comprises two mutually opposite electrodes. A pulsed nitrogen laser is provided in order to ignite the spark gap, whose laser pulses, which are in the UV range, are guided in a gas area which is bounded by the electrodes. A window which is permeable to UV light and is composed of quartz glass is provided for injection of the ignition light into the spark gap, which is surrounded by a housing. In order to reduce the energy of the light pulses that is required to ignite the spark gap, a metal aerosol is provided between the electrodes, so that ignition electron can be produced by photoemission.

DE 198 03 636 A1 discloses an overvoltage protection system with a spark gap which can be ignited via an ignition electrode. An ignition circuit is used to trigger the spark gap and comprises a capacitive voltage divider with an ignition capacitor, as well as an ignition switching element, across which a smaller voltage is dropped than across the main electrodes of the spark gap, owing to the capacitive voltage divider. If the voltage which is applied to the ignition switching element exceeds a threshold value, it is moved from a blocking position, in which current flow is interrupted, to its current-carrying on position, so that the ignition capacitor is discharged, causing a spark discharge between the ignition electrode and one of the main electrodes, and thus initiating the ignition of the main spark gap.

Spark gaps which can be actively ignited are also used as overvoltage protection for components which are arranged on high-voltage platforms that are designed to be isolated.

Overvoltage protection such as this is already known from the common prior art. FIG. 1 shows overvoltage protection such as this, which has a main spark gap 2 with main electrodes 3. The main electrodes are connected in parallel with series capacitors, which are connected to a three-phase DC voltage electrical power supply system at high-voltage potential. Bridging by means of the spark gap protects the capacitor against excessively high voltages. The series capacitors or other electronic components to be protected are arranged on a platform 4, which is designed to be isolated, and is supported on a substrate, that is at ground potential, via supporting mounts which are in the form of pillars but are not illustrated in the figures. By way of example, the main electrode 3 that is shown at the bottom in FIG. 1 is thus at a high-voltage potential which corresponds to that of the platform 4, while the main electrode 3, which is shown at the top in FIG. 1, is at the high-voltage potential of the three-phase power supply system. A voltage of between about 60 kV and 160 kV is dropped between the main electrodes, so that the components which are arranged on the platform 4 are designed for this voltage drop.

An ignition circuit 5 with an ignition electrode 6 is provided for active ignition of the spark gap 2, with the ignition circuit 5 having a capacitive voltage divider with a first capacitor 7 and an ignition capacitor 8. The ignition capacitor 8 can be bridged by a parallel path, in which an initiation spark gap 9 and a non-reactive resistor 10 connected in series with it are arranged. The initiation spark gap 9 can be triggered by control electronics 11, which allow current to flow via the parallel path, thus bridging the ignition capacitor 8. The bridging changes the ignition electrode 6 to the potential of the lower main electrode 3, which, however, is arranged physically closer to the upper main electrode 3 than the lower main electrode 3. This results in a spark discharge, which jumps over to the lower main electrode 3. The control electronics 11 can be supplied with the power required to initiate the initiation spark gap 9 via a power supply 12.

The initiation spark gap 9 is actively ignited. In this case, a protective device 13 monitors electrical measurement variables of the three-phase electrical power supply such as the alternating current in each phase of the three-phase electrical power supply, and/or the voltage which is dropped across the electronic components on the platform 4. If initiation conditions occur, such as a threshold voltage being exceeded on the component, the protective device 13 produces an initiation signal, which is transmitted to a semiconductor laser 14 which then produces an optical initiation signal which is supplied via an optical waveguide 15 to the control electronics 11. On reception of an optical initiation signal, the control electronics cause electrical initiation of the spark gap 2. The spark gap 2 is thus initiated only indirectly by means of an optical signal whose light intensity is thus matched only to the sensitivity of the optoelectrical transducer for the control electronics.

The protective device 13 as well as the semiconductor laser 14 are at a ground potential, thus making it easier to access and service them when required. The optical waveguide 15 allows safe guidance of the ignition light, while at the same time maintaining the isolation between the platform 4, which is at a high-voltage potential, and the components 13 and 14, which are at ground potential, of the overvoltage protection 1.

Because of the electronics that are required with the power supply on the platform, the already known overvoltage protection is costly and complex to maintain.

### SUMMARY

The object of the invention is to provide overvoltage protection of the type mentioned in the introduction, which allows reliable ignition of the spark gap.

The invention achieves this object by means of an optical waveguide for guiding the ignition light to the spark gap.

According to the present invention, the ignition light is guided reliably from the light source via an optical waveguide to the spark gap. For this purpose, it is necessary for the material of which the optical waveguide is composed to have sufficiently high optical transparency for the ignition light, and for light absorption with dissipative heat development as a consequence to be largely avoided. The light power which is required to ignite the spark gap is, according to the invention, so high that, after the ignition light emerges from the optical waveguide an adequate number of free charge carriers are produced by photoemission and/or multiple photon absorption or other effects, which free charge carriers are accelerated by the electrical field between the electrodes of the spark gap, forming an arc.

For the purpose of the invention, one of the electrodes of the spark gap, for example, is grounded, while in contrast the other main electrode is at a higher potential than this. However, this situation is not relevant in practice.

In one preferred embodiment of the invention, the main electrodes are, however, arranged on a platform which is designed to be electrically isolated, is at a high-voltage potential and is provided for components to be mounted on, which can be connected to a high-voltage three-phase electrical power supply system, and in that the light source is grounded. In other words, the light source is not arranged on the platform but in the surrounding area, which is grounded and to which the light source is electrically conductively connected. In this case, the overvoltage protection is used for protection of components arranged on the platform, such as capacitors, coils and the like. The optical waveguide, which has an isolating effect, extends between the platform and the grounded light source, so that this allows the spark gap to be controlled while at the same time maintaining the isolation between the platform and ground potential.

The light source expediently has a pump laser which is designed for optical pumping of a fiber laser, with an active medium of the fiber laser being formed in one section of the optical waveguide. Said section of the optical waveguide is doped with an optically active material which absorbs the pump light, so that a population invasion is made possible if the pump power is sufficiently high. In this case, the material of said section of the optical waveguide assists the laser process. Complex injection of the ignition light into the optical waveguide is avoided by means of the fiber laser. The light furthermore propagates into the optical waveguide itself after emerging from the laser resonator of the optical waveguide, so that high ignition light powers can be produced in the optical waveguide, as a function of the pump power.

Any desired pump lasers, which are known best of all to those skilled in the art, are suitable for use as pump lasers. The pump laser is therefore, for example, a solid-state laser such as an Nd-YAG laser or a semiconductor laser, which have an emission wave length in the absorption range of the optically active particles of the fiber laser.

Optics are advantageously provided for focusing of the ignition light. According to this advantageous further development, optics are provided on the platform between the spark gap and the outlet end of the optical waveguide and, after appropriate alignment, result in focusing of the ignition light in the gas area, which is bounded by the main electrodes. The focusing of the ignition light results in the light intensity in the focus area becoming so high that free electrons, or in other words a laser-induced optical breakdown, are or is produced in the spark gap as a result of non-linear interactions between the gas molecules and the laser light, for example by means of multiple photon absorption. The electrical field between the main electrodes accelerates the free electrons so that an arc is formed between the electrodes because of the resultant avalanche effect, and this results in a voltage drop across the component to be protected.

The ignition light is advantageously guided on a surface of the electrode which faces the opposite electrode. In this expedient further development, the so-called photoemission is used for spark initiation. In this case, the ignition light interacts with the surface material of the electrode. This interaction results in electrons being released from the electrode material, leading to initiation of the spark gap. Focusing of the ignition light is also possible in this case.

In contrast to this, the optical waveguide is chosen to be aligned such that the surface of the main electrode is located in the path of the ignition light that emerges from the optical waveguide. In this case, by way of example, unfocused ignition light strikes the surface of the electrode at right angles or at an acute angle. The critical factor with both variants is that the interaction between the electrode material results in the production of a sufficient number of free charge carriers for initiation of the spark gap. This avoids melting of the optical waveguide end in the ignited spark gap.

In a further refinement of the invention, the ignition light is incident between the main electrodes transversely with respect to the electrical field, with the ignition light being guided along the surface of one main electrode, and in the process resulting in electrons emerging from the surface material. In this case as well, the photoemission effect initiates the spark discharge.

That free end of the optical waveguide remote from the light source is advantageously arranged in one electrode. According to this advantageous further development, the light beam emerges from the optical waveguide parallel to the field lines of the electrical field between the main electrodes. In order to protect the optical waveguide against being melted away, the outlet end of the optical waveguide is arranged recessed in a main electrode, so that the optical waveguide remains at a distance from the ignition arc.

In one preferred exemplary embodiment, the spark gap is part of an ignition circuit for ignition of a main spark gap. The main spark gap is, for example, connected in parallel with a component to be protected against overvoltages. In this case, in order to increase the withstand voltage, the spark gap may have a plurality of spark gap elements, which are arranged connected in series with one another and only one of which is directly ignited by light. The ignition of only one or of some of the series-connected spark gap elements increases the voltage which is dropped across those spark gap elements which have not yet been ignited, so that they are likewise ignited. This applies in a corresponding manner to spark gaps which are connected in series and are not part of an ignition circuit, but are arranged directly in parallel with the component to be protected. In other words, any desired connections of spark gaps are possible according to the present invention.

### BRIEF DESCRIPTION OF THE DRAWINGS

Further expedient refinements and advantages of the invention are the subject matter of the following description of exemplary embodiments of the invention with reference to the figures of the drawing, in which components having the same effect are provided with the same reference symbols, and in which:

FIG. 1 shows one exemplary embodiment of overvoltage protection according to the prior art, and

FIG. 2 shows one exemplary embodiment of overvoltage protection according to the invention.

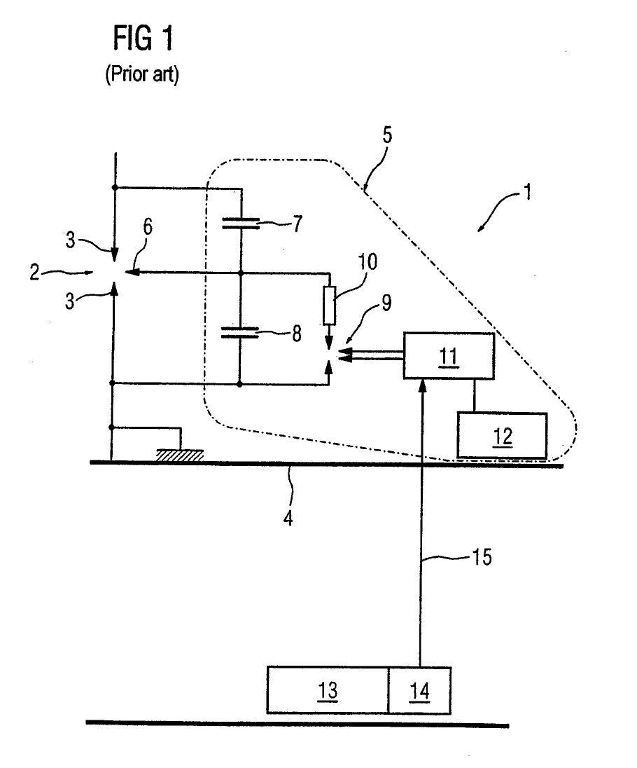

FIG. 1 shows an already known exemplary embodiment of overvoltage protection 1 according to the prior art, as has already been described further above.

### DETAILED DESCRIPTION

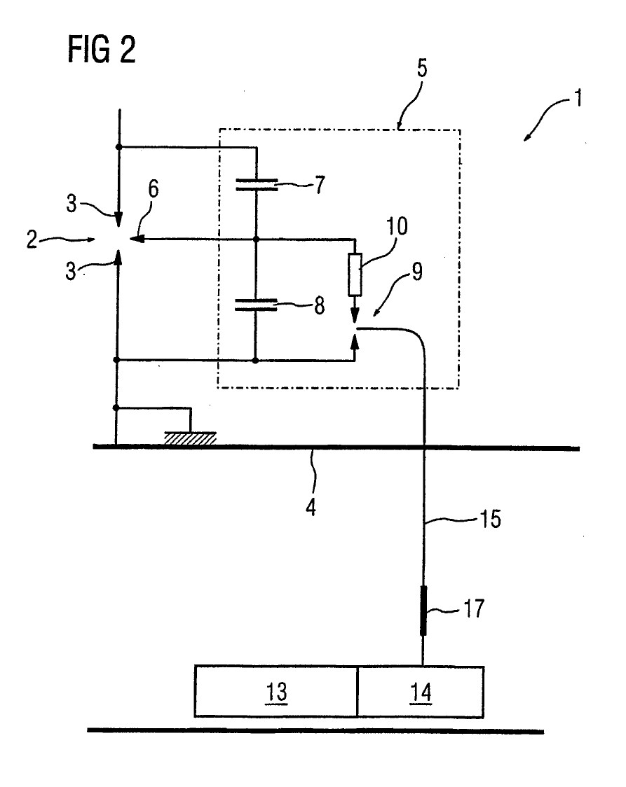

FIG. 2 shows one exemplary embodiment of overvoltage protection 1 according to the invention, which is connected in parallel with a component which is arranged on the platform 4 but is not illustrated in the figure, such as a high-voltage capacitor. In this case, the high-voltage capacitor is connected in series in one phase of a high-voltage three-phase electrical power supply system. In order to avoid high potential differences, the components which can be coupled to the high-voltage line of the three-phase electrical power supply system are arranged on the platform 4, which is held in an isolated manner on a substrate that is at ground potential, for example via supporting mounts composed of ceramic, cast resin or the like.

In the illustrated exemplary embodiment, the overvoltage protection 1 has a main spark gap 2, which comprises the main electrodes 3 and can be ignited by means of the ignition electrode 6. The ignition circuit 5 is used for initiation, is arranged—like the ignition electrode—on the platform 4, and is thus at a high-voltage potential. The ignition circuit 5 comprises a capacitive voltage divider, which comprises the capacitor 7 and the ignition capacitor 8, which are connected in series with one another. The ignition capacitor 8 can be bridged by a bridging path in which the non-reactive resistor 10 and an initiation spark gap 9, as the spark gap, are arranged in series.

In contrast, the protective device 13 as well as a pump laser 16 are at ground potential. In contrast to the laser 13 shown in FIG. 1, the pump laser 16 is not used to produce an ignition light which can be injected into the optical waveguide 15, but to pump a fiber laser 17 which is in the form of a section of the optical waveguide 15 and is composed of a host crystal which is doped with optically active particles. The host crystal, through which the pump light from the pump laser 16 can pass, assists the optically active particles to produce the population inversion, thus allowing laser operation of the fiber laser 17.

The protective device 13 is connected to measurement sensors such as voltmeters, which are not illustrated in the figures, so that the voltage which is dropped across a component to be monitored can be supplied to the protective device 13.

The overvoltage protection 1 shown in FIG. 2 acts as follows:

The protective device 13 compares the voltage values supplied from the voltmeter with, for example, a threshold value. In contrast to this, the protective device derives a voltage value from current values from the measurement devices. If the voltage values exceed the threshold value, the protective device 13 initiates an electrical initiation pulse, which is supplied to the pump laser 16. After reception of the initiation pulse, the pump laser 16 produces pump light, which releases a laser pulse in the fiber laser 17. The laser pulse in the fiber laser 17 is referred to as the ignition light. The ignition light which originates from the fiber laser 17 is passed via the optical waveguide 15 to the initiation spark gap 9, which is sealed by a housing that is not illustrated. The housing is filled with a gas. In this case, the free end of the optical waveguide is arranged in the housing such that the ignition light which emerges from the optical waveguide 15 enters the gas area, which is bounded by the electrodes, transversely with respect to the electrical field that is produced by the electrodes of the initiation spark gap 9. The laser light from the fiber laser 17 is so intensive that it produces an optical breakdown in the initiation spark gap 9, thus igniting the initiation spark gap 9. The breakdown of the spark gap 2 is produced by the circuitry that has already been described in conjunction with FIG. 1, thus protecting the component connected in parallel with it against excessively high voltages.

In one exemplary embodiment, which is not illustrated in the figures and differs from this, the optical waveguide or waveguides is or are passed directly to the main spark gap. The main spark gap can thus be ignited optically. This means that a costly ignition circuit has become superfluous. The cost advantages obtained from this compensate for the costs for the pump laser and the fiber laser.

Description

Optically Ignited Spark Gap

The invention relates to overvoltage protection having a spark gap which has mutually opposite electrodes, with a light source for production of an ignition light as a function of initiation signals from a control unit, with the ignition light being designed for direct ignition of the spark gap.

Overvoltage protection such as this is already known from DE 197 18 660 A1. The overvoltage protection described there has a spark gap which comprises two mutually opposite electrodes. A pulsed nitrogen laser is provided in order to ignite the spark gap, whose laser pulses, which are in the UV range, are guided in a gas area which is bounded by the electrodes. A window which is permeable to UV light and is composed of quartz glass is provided for injection of the ignition light into the spark gap, which is surrounded by a housing. In order to reduce the energy of the light pulses that is required to ignite the spark gap, a metal aerosol is provided between the electrodes, so that ignition electron can be produced by photoemission.

DE 198 03 636 A1 discloses an overvoltage protection system with a spark gap which can be ignited via an ignition electrode. An ignition circuit is used to trigger the spark gap and comprises a capacitive voltage divider with an ignition capacitor, as well as an ignition switching element, across which a smaller voltage is dropped than across the main electrodes of the spark gap, owing to the capacitive voltage divider. If the voltage which is applied to the ignition switching element exceeds a threshold value, it is moved from a blocking position, in which current flow is interrupted, to its current-carrying on position, so that the ignition capacitor is discharged, causing a spark discharge between the ignition electrode and one of the main electrodes, and thus initiating the ignition of the main spark gap.

Spark gaps which can be actively ignited are also used as overvoltage protection for components which are arranged on high-voltage platforms that are designed to be isolated.

Overvoltage protection such as this is already known from the common prior art. FIG. 1 shows overvoltage protection such as this, which has a main spark gap 2 with main electrodes 3. The main electrodes are connected in parallel with series capacitors, which are connected to a three-phase DC voltage electrical power supply system at high-voltage potential. Bridging by means of the spark gap protects the capacitor against excessively high voltages. The series capacitors or other electronic components to be protected are arranged on a platform 4, which is designed to be isolated, and is supported on a substrate, that is at ground potential, via supporting mounts which are in the form of pillars but are not illustrated in the figures. By way of example, the main electrode 3 that is shown at the bottom in FIG. 1 is thus at a high-voltage potential which corresponds to that of the platform 4, while the main electrode 3, which is shown at the top in FIG. 1, is at the high-voltage potential of the three-phase power supply system. A voltage of between about 60 kV and 160 kV is dropped between the main electrodes, so that the components which are arranged on the platform 4 are designed for this voltage drop.

An ignition circuit 5 with an ignition electrode 6 is provided for active ignition of the spark gap 2, with the ignition circuit 5 having a capacitive voltage divider with a first capacitor 7 and an ignition capacitor 8. The ignition capacitor 8 can be bridged by a parallel path, in which an initiation spark gap 9 and a non-reactive resistor 10 connected in series with it are arranged. The initiation spark gap 8 can be triggered by control electronics 11, which allow current to flow via the parallel path, thus bridging the ignition capacitor 8. The bridging changes the ignition electrode 6 to the potential of the lower main electrode 3, which, however, is arranged physically closer to the upper main electrode 3 than the lower main electrode 3. This results in a spark discharge, which jumps over to the lower main electrode 3. The control electronics 11 can be supplied with the power required to initiate the initiation spark gap 9 via a power supply 12.

The initiation spark gap 9 is actively ignited. In this case, a protective device 13 monitors electrical measurement variables of the three-phase electrical power supply such as the alternating current in each phase of the three-phase electrical power supply, and/or the voltage which is dropped across the electronic components on the platform 4. If initiation conditions occur, such as a threshold voltage being exceeded on the component, the protective device 13 produces an initiation signal, which is transmitted to a semiconductor laser 14 which then produces an optical initiation signal which is supplied via an optical waveguide 15 to the control electronics 11. On reception of an optical initiation signal, the control electronics cause electrical initiation of the spark gap 2. The spark gap 2 is thus initiated only indirectly by means of an optical signal whose light intensity is thus matched only to the sensitivity of the optoelectrical transducer for the control electronics.

The protective device 13 as well as the semiconductor laser 14 are at a ground potential, thus making it easier to access and service them when required. The optical waveguide 15 allows safe guidance of the ignition light, while at the same time maintaining the isolation between the platform 4, which is at a high-voltage potential, and the components 13 and 14, which are at ground potential, of the overvoltage protection 1.

Because of the electronics that are required with the power supply on the platform, the already known overvoltage protection is costly and complex to maintain.

The object of the invention is to provide overvoltage protection of the type mentioned in the introduction, which allows reliable ignition of the spark gap.

The invention achieves this object by means of an optical waveguide for guiding the ignition light to the spark gap.

According to the present invention, the ignition light is guided reliably from the light source via an optical waveguide to the spark gap. For this purpose, it is necessary for the material of which the optical waveguide is composed to have sufficiently high optical transparency for the ignition light, and for light absorption with dissipative heat development as a consequence to be largely avoided. The light power which is required to ignite the spark gap is, according to the invention, so high that, after the ignition light emerges from the optical waveguide an adequate number of free charge carriers are produced by photoemission and/or multiple photon absorption or other effects, which free charge carriers are accelerated by the electrical field between the electrodes of the spark gap, forming an arc.

For the purpose of the invention, one of the electrodes of the spark gap, for example, is grounded, while in contrast the other main electrode is at a higher potential than this. However, this situation is not relevant in practice.

In one preferred embodiment of the invention, the main electrodes are, however, arranged on a platform which is designed to be electrically isolated, is at a high-voltage potential and is provided for components to be mounted on, which can be connected to a high-voltage three-phase electrical power supply system, and in that the light source is grounded. In other words, the light source is not arranged on the platform but in the surrounding area, which is grounded and to which the light source is electrically conductively connected. In this case, the overvoltage protection is used for protection of components arranged on the platform, such as capacitors, coils and the like. The optical waveguide, which has an isolating effect, extends between the platform and the grounded light source, so that this allows the spark gap to be controlled while at the same time maintaining the isolation between the platform and ground potential.

The light source expediently has a pump laser which is designed for optical pumping of a fiber laser, with an active medium of the fiber laser being formed in one section of the optical waveguide. Said section of the optical waveguide is doped with an optically active material which absorbs the pump light, so that a population invasion is made possible if the pump power is sufficiently high. In this case, the material of said section of the optical waveguide assists the laser process. Complex injection of the ignition light into the optical waveguide is avoided by means of the fiber laser. The light furthermore propagates into the optical waveguide itself after emerging from the laser resonator of the optical waveguide, so that high ignition light powers can be produced in the optical waveguide, as a function of the pump power.

Any desired pump lasers, which are known best of all to those skilled in the art, are suitable for use as pump lasers. The pump laser is therefore, for example, a solid-state laser such as an Nd-YAG laser or a semiconductor laser, which have an emission wave length in the absorption range of the optically active particles of the fiber laser.

Optics are advantageously provided for focusing of the ignition light. According to this advantageous further development, optics are provided on the platform between the spark gap and the outlet end of the optical waveguide and, after appropriate alignment, result in focusing of the ignition light in the gas area, which is bounded by the main electrodes. The focusing of the ignition light results in the light intensity in the focus area becoming so high that free electrons, or in other words a laser-induced optical breakdown, are or is produced in the spark gap as a result of non-linear interactions between the gas molecules and the laser light, for example by means of multiple photon absorption. The electrical field between the main electrodes accelerates the free electrons so that an arc is formed between the electrodes because of the resultant avalanche effect, and this results in a voltage drop across the component to be protected.

The ignition light is advantageously guided on a surface of the electrode which faces the opposite electrode. In this expedient further development, the so-called photoemission is used for spark initiation. In this case, the ignition light interacts with the surface material of the electrode. This interaction results in electrons being released from the electrode material, leading to initiation of the spark gap. Focusing of the ignition light is also possible in this case.

In contrast to this, the optical waveguide is chosen to be aligned such that the surface of the main electrode is located in the path of the ignition light that emerges from the optical waveguide. In this case, by way of example, unfocused ignition light strikes the surface of the electrode at right angles or at an acute angle. The critical factor with both variants is that the interaction between the electrode material results in the production of a sufficient number of free charge carriers for initiation of the spark gap. This avoids melting of the optical waveguide end in the ignited spark gap.

In a further refinement of the invention, the ignition light is incident between the main electrodes transversely with respect to the electrical field, with the ignition light being guided along the surface of one main electrode, and in the process resulting in electrons emerging from the surface material. In this case as well, the photoemission effect initiates the spark discharge.

That free end of the optical waveguide remote from the light source is advantageously arranged in one electrode. According to this advantageous further development, the light beam emerges from the optical waveguide parallel to the field lines of the electrical field between the main electrodes. In order to protect the optical waveguide against being melted away, the outlet end of the optical waveguide is arranged recessed in a main electrode, so that the optical waveguide remains at a distance from the ignition arc.

In one preferred exemplary embodiment, the spark gap is part of an ignition circuit for ignition of a main spark gap. The main spark gap is, for example, connected in parallel with a component to be protected against overvoltages. In this case, in order to increase the withstand voltage, the spark gap may have a plurality of spark gap elements, which are arranged connected in series with one another and only one of which is directly ignited by light. The ignition of only one or of some of the series-connected spark gap elements increases the voltage which is dropped across those spark gap elements which have not yet been ignited, so that they are likewise ignited. This applies in a corresponding manner to spark gaps which are connected in series and are not part of an ignition circuit, but are arranged directly in parallel with the component to be protected. In other words, any desired connections of spark gaps are possible according to the present invention.

Further expedient refinements and advantages of the invention are the subject matter of the following description of exemplary embodiments of the invention with reference to the figures of the drawing, in which components having the same effect are provided with the same reference symbols, and in which:

FIG. 1 shows one exemplary embodiment of overvoltage protection according to the prior art, and

FIG. 2 shows one exemplary embodiment of overvoltage protection according to the invention.

FIG. 1 shows an already known exemplary embodiment of overvoltage protection 1 according to the prior art, as has already been described further above.

FIG. 2 shows one exemplary embodiment of overvoltage protection 1 according to the invention, which is connected in parallel with a component which is arranged on the platform 4 but is not illustrated in the figure, such as a high-voltage capacitor. In this case, the high-voltage capacitor is connected in series in one phase of a high-voltage three-phase electrical power supply system. In order to avoid high potential differences, the components which can be coupled to the high-voltage line of the three-phase electrical power supply system are arranged on the platform 4, which is held in an isolated manner on a substrate that is at ground potential, for example via supporting mounts composed of ceramic, cast resin or the like.

In the illustrated exemplary embodiment, the overvoltage protection 1 has a main spark gap 2, which comprises the main electrodes 3 and can be ignited by means of the ignition electrode 6. The ignition circuit 5 is used for initiation, is arranged—like the ignition electrode—on the platform 4, and is thus at a high-voltage potential. The ignition circuit 5 comprises a capacitive voltage divider, which comprises the capacitor 7 and the ignition capacitor 8, which are connected in series with one another. The ignition capacitor 8 can be bridged by a bridging path in which the non-reactive resistor 10 and an initiation spark gap 9, as the spark gap, are arranged in series.

In contrast, the protective device 13 as well as a pump laser 16 are at ground potential. In contrast to the laser 13 shown in FIG. 1, the pump laser 16 is not used to produce an ignition light which can be injected into the optical waveguide 15, but to pump a fiber laser 17 which is in the form of a section of the optical waveguide 15 and is composed of a host crystal which is doped with optically active particles. The host crystal, through which the pump light from the pump laser 16 can pass, assists the optically active particles to produce the population inversion, thus allowing laser operation of the fiber laser 17.

The protective device 13 is connected to measurement sensors such as voltmeters, which are not illustrated in the figures, so that the voltage which is dropped across a component to be monitored can be supplied to the protective device 13.

The overvoltage protection 1 shown in FIG. 2 acts as follows: The protective device 13 compares the voltage values supplied from the voltmeter with, for example, a threshold value. In contrast to this, the protective device derives a voltage value from current values from the measurement devices. If the voltage values exceed the threshold value, the protective device 13 initiates an electrical initiation pulse, which is supplied to the pump laser 16. After reception of the initiation pulse, the pump laser 16 produces pump light, which releases a laser pulse in the fiber laser 17. The laser pulse in the fiber laser 17 is referred to as the ignition light. The ignition light which originates from the fiber laser 17 is passed via the optical waveguide 15 to the initiation spark gap 9, which is sealed by a housing that is not illustrated. The housing is filled with a gas. In this case, the free end of the optical waveguide is arranged in the housing such that the ignition light which emerges from the optical waveguide 15 enters the gas area, which is bounded by the electrodes, transversely with respect to the electrical field that is produced by the electrodes of the initiation spark gap 9. The laser light from the fiber laser 17 is so intensive that it produces an optical breakdown in the initiation spark gap 8, thus igniting the initiation spark gap 8. The breakdown of the spark gap 3 is produced by the circuitry that has already been described in conjunction with FIG. 1, thus protecting the component connected in parallel with it against excessively high voltages.

In one exemplary embodiment, which is not illustrated in the figures and differs from this, the optical waveguide or waveguides is or are passed directly to the main spark gap. The main spark gap can thus be ignited optically. This means that a costly ignition circuit has become superfluous. The cost advantages obtained from this compensate for the costs for the pump laser and the fiber laser.

What is claimed is:

1. An overvoltage protection comprising:
a spark gap which has mutually opposite electrodes
a light source for production of an ignition light as a function of initiation signals from a control unit, wherein the ignition light designed for direct ignition of the spark gap,
an optical waveguide for carrying the ignition light to the spark gap.

2. An overvoltage protection according to claim 1, wherein the electrodes are arranged on a platform which is designed to be electrically isolated, at a high-voltage potential, and provided for components to be mounted on, wherein the components can be connected to a high-voltage three-phase electrical power supply system, and wherein the light source is grounded.

3. An overvoltage protection according to claim 1, wherein the light source has a pump laser which is designed for optical pumping of a fiber laser, with an active medium of the fiber laser being formed in one section of the optical waveguide.

4. An overvoltage protection according to claim 1, comprising optics for focusing of the ignition light.

5. An overvoltage protection according to claim 1, wherein the ignition light is guided on a surface of the electrode facing the opposite electrode.

6. An overvoltage protection according to claim 1, wherein the free end of the optical waveguide remote from the light source is arranged in one electrode.

7. An overvoltage protection according to claim 1, wherein the spark gap is part of an ignition circuit for ignition of a main spark gap.

8. An overvoltage protection comprising:
a spark gap which has mutually opposite electrodes,
an ignition light source receiving initiation signals from a control unit, wherein the ignition light is designed for direct ignition of the spark gap, and
an optical waveguide for carrying the ignition light to the spark gap.

9. An overvoltage protection according to claim 8, wherein the electrodes are arranged on a platform which is designed to be electrically isolated, at a high-voltage potential, and provided for components to be mounted on, wherein the components can be connected to a high-voltage three-phase electrical power supply system, and wherein the light source is grounded.

10. An overvoltage protection according to claim 8, wherein the light source has a pump laser which is designed for optical pumping of a fiber laser, with an active medium of the fiber laser being formed in one section of the optical waveguide.

11. An overvoltage protection according to claim 8, comprising optics for focusing of the ignition light.

12. An overvoltage protection according to claim 8, wherein the ignition light is guided on a surface of the electrode facing the opposite electrode.

13. An overvoltage protection according to claim 8, wherein the free end of the optical waveguide remote from the light source is arranged in one electrode.

14. An overvoltage protection according to claim 8, wherein the spark gap is part of an ignition circuit for ignition of a main spark gap.

15. An overvoltage protection comprising:
a spark gap which has mutually opposite electrodes,
a light source for production of an ignition light as a function of initiation signals from a control unit, wherein the ignition light is designed for direct ignition of the spark gap, and
an optical waveguide for carrying the ignition light to the spark gap,
wherein the electrodes are arranged on a platform which is designed to be electrically isolated, at a high-voltage potential, and provided for components to be mounted on, wherein the components can be connected to a high-voltage three-phase electrical power supply system, and wherein the light source is grounded.

16. An overvoltage protection according to claim 15, wherein the light source has a pump laser which is designed for optical pumping of a fiber laser, with an active medium of the fiber laser being formed in one section of the optical waveguide.

17. An overvoltage protection according to claim 15, comprising optics for focusing of the ignition light.

18. An overvoltage protection according to claim 15, wherein the ignition light is guided on a surface of the electrode facing the opposite electrode.

19. An overvoltage protection according to claim 15, wherein the free end of the optical waveguide remote from the light source is arranged in one electrode.

20. An overvoltage protection according to claim 15, wherein the spark gap is part of an ignition circuit for ignition of a main spark gap.
